(19) United States
(12) Patent Application Publication
(10) Pub. No.: US 2018/0324833 A1
(43) Pub. Date: Nov. 8, 2018

(54) ENHANCEMENTS TO LOGIC CHANNEL PRIORITIZATION PROCEDURE WITH MULTIPLE NUMEROLOGIES

(71) Applicant: QUALCOMM Incorporated, San Diego, CA (US)

(72) Inventors: Linhai HE, San Diego, CA (US); Aziz GHOLMIEH, Del Mar, CA (US); Sitaramanjaneyulu KANAMARLAPUDI, San Diego, CA (US); Srinivasan BALASUBRAMANIAN, San Diego, CA (US)

(21) Appl. No.: 15/969,436

(22) Filed: May 2, 2018

Related U.S. Application Data
(60) Provisional application No. 62/502,426, filed on May 5, 2017.

(51) Int. Cl. H04W 72/12; H04L 12/819; H04L 5/00

(52) U.S. Cl. CPC H04W 72/1242; H04W 72/10; H04L 5/0064; H04L 47/21

(57) ABSTRACT

Aspects of the present disclosure implement techniques for enhancing the LCP procedures that enables UEs to share resources more efficiently among different services and applications when the UE is configured with multiple numerologies. Particularly, each logical channel may be configured with a pair of total PBR and BSD by the network entity. For a logical channel mapped to multiple numerologies, network entity may configure a pair of prioritized bit rate (PBR) and bucket size duration (BSR) for each of its numerologies, with the constraint that the sum of the PBRs and BSDs allocated for the individual numerologies may equal its total PBR and BSR.

### CROSS-REFERENCE TO RELATED APPLICATION(S)

This application claims benefit of U.S. Provisional Application Ser. No. 62/502,426, entitled “ENHANCEMENTS TO LOGIC CHANNEL PRIORITIZATION PROCEDURE WITH MULTIPLE NUMEROLOGIES” and filed May 5, 2017, which is expressly incorporated by reference herein in its entirety.

### BACKGROUND

Aspects of the present disclosure relate generally to wireless communication networks, and more particularly to extending the logical channel prioritization (LCP) procedure in the long term evolution (LTE) baseline in order to support multiple numerologies in New Radio (NR).

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, and single-carrier frequency division multiple access (SC-FDMA) systems

These multiple access technologies have been adopted in various telecommunication standards to provide a common protocol that enables different wireless devices to communicate on a municipal, national, regional, and even global level. For example, 5G new radio (NR) communications technology is envisaged to expand and support diverse usage scenarios and applications with respect to current mobile network generations. In an aspect, 5G communications technology includes enhanced mobile broadband addressing human-centric use cases for access to multimedia content, services and data; ultra-reliable-low latency communications (URLLC) with strict requirements, especially in terms of latency and reliability; and massive machine type communications for a very large number of connected devices and typically transmitting a relatively low volume of non-delay-sensitive information. As the demand for mobile broadband access continues to increase, however, there exists a need for further improvements in 5G communications technology and beyond.

Particularly, in some aspects, the LCP procedure may control scheduling of uplink traffic (e.g., data) among a plurality of logical channels. In conventional systems (e.g., LTE deployments), each logical channel utilized the LCP procedure by setting three parameters configured by radio resource control (RRC): priority parameter; prioritized bit rate (PBR); and bucket size duration (BSD). The priority parameter may set the priority of a logical channel when sharing uplink resources configured by base station. PBR parameter may set the guaranteed bit rate on the uplink for the logical channel. The BSD parameter may set the maximum burst size for the logical channel.

In NR communications technology, however, a logical channel may be mapped to multiple numerologies. As such, adopting the LCP procedures from conventional LTE systems into NR communications technology may raise potential problems. For example, in some examples, it may be unclear how the above three parameters (e.g., priority, PBR, and BSD) may be configured on different numerologies of a logical channel. Additionally, with multiple numerologies, a user equipment (UE) may receive multiple uplink grants from the network. In such situations, using the conventional techniques to process the multiple uplink grants may raise processing challenges for the UE.

### SUMMARY

Aspects of the present disclosure address the above-identified problem by providing techniques for enhancing the LCP procedures that enables UEs to share resources more efficiently among different services and applications when the UE is configured with multiple numerologies.

In one example, a method, apparatus, and computer readable medium for wireless communications implemented by a base station is disclosed. The process may include configuring, at the base station, a total PBR parameter value and a total BSD parameter value for a logical channel. The method may further include configuring a sub-PBR parameter value and a sub-BSD parameter value for each of a plurality of numerologies in the logical channel. The sum of the sub-PBR parameter value and the sub-BSD parameter value for each of the plurality of numerologies may be equal to the total PBR and BSD value. The method may further include transmitting (e.g., signaling) information associated with the sub-PBR parameter value and the sub-BSD parameter value to the UE.

In another example, another method, apparatus, and computer readable medium for wireless communications implemented by a UE is disclosed. The method may include receiving, at the UE, a plurality of uplink grants from a base station. The plurality of uplink grants may be for a plurality of numerologies associated with a logical channel. The method may further include determining whether to include the logical channel for LCP procedure based on receiving the plurality of uplink grants. The method may further include transmitting an uplink traffic to the base station based on the determining.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communications system in accordance with aspects of the present disclosure;

FIG. 2 is a schematic diagram of an aspect of an implementation of various components of base station in accordance with various aspects of the present disclosure;

FIG. 3 illustrates a method of wireless communication implemented by a base station in accordance with aspects of the present disclosure;

FIG. 4 is a schematic diagram of an aspect of an implementation of various components of a user equipment in accordance with various aspects of the present disclosure;

FIG. 5 illustrates a method of wireless communication implemented by the UE in accordance with aspects of the present disclosure.

### DETAILED DESCRIPTION

As discussed above, the logical channel prioritization (LCP) procedure may control scheduling of uplink traffic (e.g., data) among a plurality of logical channels. In previous systems, each logical channel utilized the LCP procedure by setting three parameters configured by radio resource control (RRC): priority parameter; prioritized bit rate (PBR); and bucket size duration (BSD). However, employing similar techniques for 5G new radio (NR) communications technology presents unique challenges, including resolving issues associated with a logical channel that may be mapped to multiple numerologies and the UE receiving multiple uplink grants from the network. For purposes of this disclosure, the term “numerology” may refer to aspects associated with subcarrier spacing and/or symbol length. Thus, one numerology may correspond to one subcarrier spacing in frequency domain. The choice of the numerology may be driven by the propagation environment to be supported in conjunction with the service needs and the degree of freedom for control signaling elements, such as pilot symbols.

Aspects of the present disclosure provide techniques that allow the UE to share resources more efficiently among different services and applications when it is configured with multiple numerologies. Particularly, features of the present disclosure focus on configuration of the PBR and BSD parameters that may be adapted for 5G NR systems. In some aspects, with respect to configuring the parameters associated with the LCP, the network entity (e.g., base station) may be configured to set the PBR and BSD parameter values. The PBR and BSD parameters values may be set by the network such that the sum of the parameters (e.g., PBR and BSD) for individual numerologies may equal the total configured for the logical channel (referred herein as the “total PBR” and “total BSD”). For example, in some examples, RRC may configure a total PBR of r_{LCH} for a logical channel, which is mapped to numerology 1 and 2 (e.g., first numerology and second numerology). Further, the sub-PBR configured for numerology 1 and 2 may be r₁ and r₂, respectively. In such situations, r_{LCH} may then equal r₁+r₂. The same requirement may apply to BSD as well. For example, the RRC may configure a total BSD for a logical channel, which is mapped to first and second numerology where the total BSD may be combination of the first and second sub-BSDs. The network entity (e.g., base station) may transmit the total PBR and BSD parameter values to the UE either explicitly (e.g., transmitting the set parameter values) or may provide information regarding the ratio of the allocation to the UE. In other examples, the UE may set the PBR and BSD parameter values itself. Thus, in some aspects, total BSD/PBR, and BSD/PBR specific to numerology can be signaled to the UE on a per logical channel basis. In other examples, total BSD may be given per logical channel where one configuration parameter for PBR/BSD may be split across numerologies.

Thus, aspects of the present disclosure provide multiple options for how the sub-PBR and sub-BSD parameters may be configured on different numerologies. In accordance with aspects of the first technique, the UE may determine how to configure sub-PBR and sub-BSD. However, such determination may be implementation specific. In accordance with aspects of the second technique, each numerology to which the logical channel is mapped may be configured with its own set of sub-PBR and sub-BSR parameters.

Aspects of the first technique may be motivated by the fact that traffic mix on a logical channel may be dynamic over time. As such, the UE may be in better position than the network to know the nature and mix of traffic (e.g., through indications from applications) and adjust the LCP parameters. However, on the other hand, if the UE is left to set the LCP parameters on individual numerologies, network may lose flexibility in configuring how a UE may share resources on different numerologies.

For example, logical channel 1 (LC1) and logical channel 2 (LC2) may be mapped to Ultra-Reliable and Low Latency Communications (URLLC) numerology, while logical channel 3 (LC3) may be mapped to both URLLC and enhanced Mobile Broadband (eMBB) numerologies. In such situation, LC3 may have lower priority than LC1 and LC2. However, the network may not want the UE to use URLLC unless there are spare resources. In such situations, if the UE has full control on how to split its total PBR between the two numerologies, then network may not be able to enforce the priority it wants for LC3 (i.e. LC3 can't use URLLC unless there are spare resources). To resolve this situation, the network may set the PBR of LC1 and LC2 on URLLC to infinity in order to ensure LC1 and LC2 have strict priority over LC3. Unfortunately, such adjustment may result in the network losing the ability to differentiate between LC1 and LC2.

Features of the present disclosure address the above conundrum. Particularly, each logical channel may be configured with a pair of total PBR and BSD by the network entity. For a logical channel mapped to multiple numerologies, network entity may configure a pair of PBR and BSD for each of its numerologies, with the constraint that the sum of the PBRs and BSDs allocated for the individual numerologies may equal its total PBR and BSR.

In other examples, when the UE receives multiple uplink grants, the UE may need to determine the set of logical channels to perform multiplexing. If only a single uplink grant is available from the network, the UE may consider all eligible logical channels. If, however, multiple uplink grants for a plurality of numerologies are available, the UE may have the option to decide whether a logical channel is to be included in the LCP procedure for a numerology. In one aspects, the UE receiving multiple uplink grants may perform the LCP procedure on one numerology at a time. The processing order for different numerologies may be configured by the network entity. However, in other aspects, the UE may determine the order of processing.

Thus, when the UE receives multiple uplink grants for different numerologies, the UE, in some examples, may select a set of logical channels to include in its LCP procedures for each numerology with a grant. The UE may begin with the numerology with the highest processing priority. Accordingly, the UE may perform the LCP procedure on the selected logical channels for this numerology. The UE may repeat the above-identified process until all uplink grants are processed based on the processing priorities determined by the network entity or selected by the UE itself.

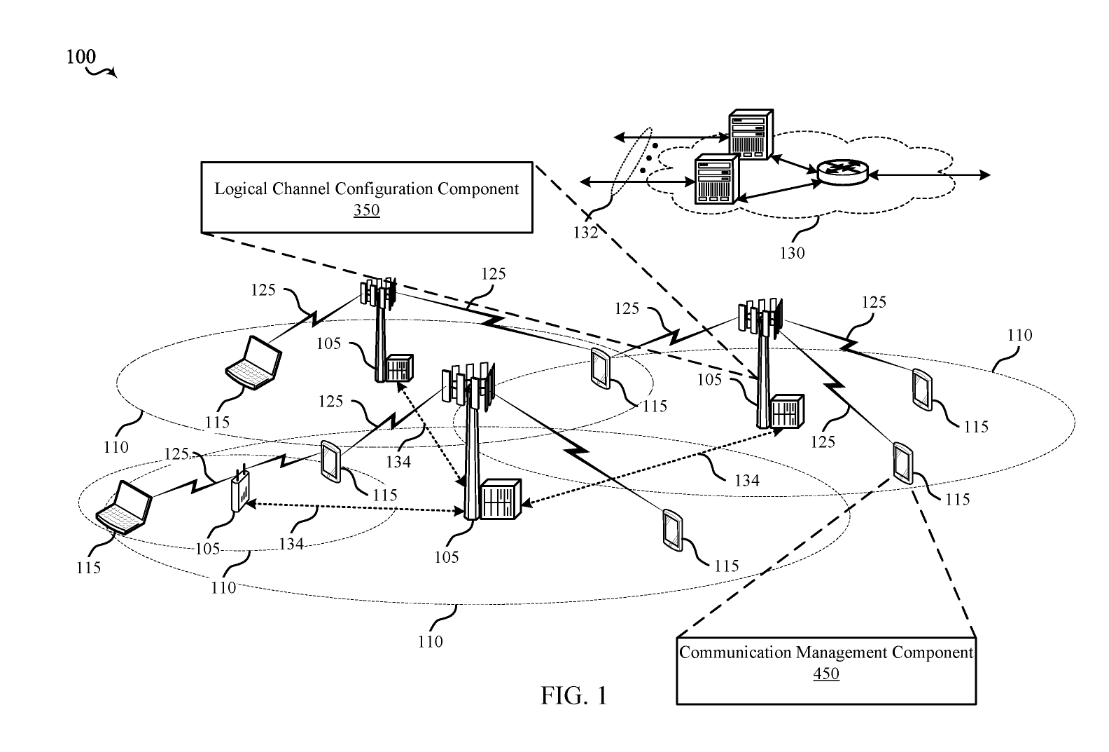

Various aspects are now described in more detail with reference to the FIGS. 1-5. In the following description, for purposes of explanation, numerous specific details are set forth in order to provide a thorough understanding of one or more aspects. It may be evident, however, that such aspect(s) may be practiced without these specific details. Additionally, the term “component” as used herein may be one of the parts that make up a system, may be hardware, firmware, and/or software stored on a computer-readable medium, and may be divided into other components.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Referring to FIG. 1, in accordance with various aspects of the present disclosure, an example wireless communication network 100 may include one or more base stations 105, one or more UEs 115, and a core network 130. The core network 130 may provide user authentication, access authorization, tracking, internet protocol (IP) connectivity, and other access, routing, or mobility functions. The base stations 105 may interface with the core network 130 through backhaul links 134 (e.g., S1, etc.). The base stations 105 may perform radio configuration and scheduling for communication with the UEs 115, or may operate under the control of a base station controller (not shown). In various examples, the base stations 105 may communicate, either directly or indirectly (e.g., through core network 130), with one another over backhaul links 134 (e.g., X1, etc.), which may be wired or wireless communication links. In some examples, one or more UEs 115 may include a communication management component 450 to perform one or more techniques and methods described herein.

The base stations 105 may wirelessly communicate with the UEs 115 via one or more base station antennas. Each of the base stations 105 may provide communication coverage for a respective geographic coverage area 110. In some examples, base stations 105 may be referred to as a base transceiver station, a radio base station, an access point, a radio transceiver, a NodeB, eNodeB (eNB), Home NodeB, a Home eNodeB, gNodeB, gNB, a relay, or some other suitable terminology. The geographic coverage area 110 for a base station 105 may be divided into sectors or cells making up only a portion of the coverage area (not shown). The wireless communication network 100 may include base stations 105 of different types (e.g., macro base stations or small cell base stations, described below). Additionally, the plurality of base stations 105 may operate according to different ones of a plurality of communication technologies (e.g., 5G, 4G/LTE, 3G, Wi-Fi, Bluetooth, etc.), and thus there may be overlapping geographic coverage areas 110 for different communication technologies.

The base station 105 may include a logical channel configuration component 350 for configuring a total PBR parameter value and a total BSD parameter value for a logical channel. The logical channel configuration component 350 may further include logical channel prioritization component 355 for configuring a sub-PBR parameter value and a sub-BSD parameter value for each of a plurality of numerologies in the logical channel. The sum of the sub-PBR parameter value and the sub-BSD parameter value for each of the plurality of numerologies may be equal to the total PBR and BSD value. Additionally or alternatively, the logical channel configuration component 350 may set forth deciding how the UE may perform the LCP procedure among a plurality of numerologies (e.g., whether the uplink grants should be processed jointly or one after another). The base station 105 may transmit the configuration information the UE 115 for logical channel configuration by the UE 115. In some examples, determining whether to include a logical channel for LCP procedure may include determining one or both of type of data or amount of data scheduled for the logical channel, and determining whether to include or exclude the logical channel for the LCP procedure for a numerology for the plurality of numerologies based on the one or both of the type of data or the amount of data scheduled for the logical channel

In some examples, the wireless communication network 100 may be or include a Long Term Evolution (LTE) or LTE-Advanced (LTE-A) technology network. The wireless communication network 100 may also be a next generation technology network, such as a 5G wireless communication network. In LTE/LTE-A networks, the term evolved node B (eNB) or gNB may be generally used to describe the base stations 105, while the term UE may be generally used to describe the UEs 115. The wireless communication network 100 may be a heterogeneous LTE/LTE-A network in which different types of eNBs provide coverage for various geographical regions. For example, each eNB or base station 105 may provide communication coverage for a macro cell, a small cell, or other types of cell. The term “cell” is a 3GPP term that can be used to describe a base station, a carrier or component carrier associated with a base station, or a coverage area (e.g., sector, etc.) of a carrier or base station, depending on context.

A macro cell may generally cover a relatively large geographic area (e.g., several kilometers in radius) and may allow unrestricted access by the UEs 115 with service subscriptions with the network provider. A small cell may include a relative lower transmit-powered base station, as compared with a macro cell, that may operate in the same or different frequency bands (e.g., licensed, unlicensed, etc.) as macro cells. Small cells may include pico cells, femto cells, and micro cells according to various examples. A pico cell, for example, may cover a small geographic area and may allow unrestricted access by the UEs 115 with service subscriptions with the network provider. A femto cell may also cover a small geographic area (e.g., a home) and may provide restricted access and/or unrestricted access by the UEs 115 having an association with the femto cell (e.g., in the restricted access case, the UEs 115 in a closed subscriber group (CSG) of the base station 105, which may include the UEs 115 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers).

The communication networks that may accommodate some of the various disclosed examples may be packet-based networks that operate according to a layered protocol stack and data in the user plane may be based on the IP. A radio link control (RLC) layer may perform packet segmentation and reassembly to communicate over logical channels. A MAC layer may perform priority handling and multiplexing of logical channels into transport channels. The MAC layer may also use HARQ to provide retransmission at the MAC layer to improve link efficiency. In the control plane, the radio resource control (RRC) protocol layer may provide establishment, configuration, and maintenance of an RRC connection between a UE 115 and the base stations 105. The RRC protocol layer may also be used for core network 130 support of radio bearers for the user plane data. At the physical (PHY) layer, the transport channels may be mapped to physical channels.

The UEs 115 may be dispersed throughout the wireless communication network 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, an entertainment device, a vehicular component, or any device capable of communicating in wireless communication network 100. Additionally, a UE 115 may be Internet of Things (IoT) and/or machine-to-machine (M2M) type of device, e.g., a low power, low data rate (relative to a wireless phone, for example) type of device, that may in some aspects communicate infrequently with wireless communication network 100 or other UEs. A UE 115 may be able to communicate with various types of base stations 105 and network equipment including macro eNBs, small cell eNBs, relay base stations, and the like.

A UE 115 may be configured to establish one or more wireless communication links 125 with one or more base stations 105. The wireless communication links 125 shown in wireless communication network 100 may carry UL transmissions from a UE 115 to a base station 105, or downlink (DL) transmissions, from a base station 105 to a UE 115. The downlink transmissions may also be called forward link transmissions while the uplink transmissions may also be called reverse link transmissions. Each wireless communication link 125 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. In an aspect, the communication links 125 may transmit bidirectional communications using frequency division duplex (FDD) (e.g., using paired spectrum resources) or time division duplex (TDD) operation (e.g., using unpaired spectrum resources). Frame structures may be defined for FDD (e.g., frame structure type 1) and TDD (e.g., frame structure type 2). Moreover, in some aspects, the communication links 125 may represent one or more broadcast channels.

The UE 115 may include communication management component 450 for configuring sub-PBR and sub-BSD on different numerologies for the logical channel. In some examples, the UE 115 may decide to configure the sub-PBR and sub-BSD based on implementation of the system. Alternatively, each numerology to which the logical channel is mapped may be configured with its own set of sub-PBR and sub-BSR parameters assigned by the base station 105. In either event, the sum of the parameters for individual numerologies may be equal the total PBR and total BSD configured for the logical channel. For a logical channel mapped to multiple numerologies, network should configure a pair of PBR and BSD for each of its numerologies, with the constraint that the sum of the PBRs and BSDs allocated for the individual numerologies should equal its total PBR and BSR.

Additionally, the communication management component 450 may process the uplink grants received from the base station 105. In some examples, when processing an uplink grant, the LCP procedure may need to determine the set of logical channels to perform multiplexing. If only a single UL grant is available, the communication management component 450 of the UE may consider all eligible logical channels mapped to the numerology because it may be desirable to send out data (including control elements) sooner rather than waiting for a possible grant on an alternative numerology. For example, suppose MAC CEs are mapped to numerologies configured for URLLC and eMBB. In such situation, if UE 115 receives a grant for eMBB, it should send out MAC CEs without waiting for a possible grant for URLLC. This is because although the latter (alternative uplink grant for URLLC) may be more reliable and have low latency, the UE 115 cannot know for sure if and when the second uplink grant may come. As such, the UE 115 may consider all eligible logical channels mapped to the numerology for uplink transmission.

However, when multiple uplink grants are available, a logical channel does not have to be included in the LCP procedure for every numerology for which it is eligible. This is because in some cases selective participation is better. As such, in some situations, the communication management component 450 may elect to omit selection of the logical channel for the LCP procedure. For instance, in some situation, a logical channel may be mapped to numerologies configured for both URLLC and eMBB and uplink grants for both numerologies may be received by the UE 115. If the grant for URLLC is small, but the grant for eMBB is large enough to send all buffered data from that logical channel, UE 115 may choose not to include that logical channel in the LCP procedure for URLLC numerology.

Similarly, if a logical channel is mapped to two numerologies with different bandwidth and reliabilities and if the UE 115 knows (e.g. from indication by application) that the buffered data for that logical channel are control messages and require higher reliability, the UE 115 should include those data in the LCP procedure for the reliable numerology only. Therefore, we believe that when multiple grants for different numerologies are available, UE should decide if a logical channel should be included in the LCP procedure for every one of those numerologies.

In some aspects of the wireless communication network 100, base stations 105 or UEs 115 may include multiple antennas for employing antenna diversity schemes to improve communication quality and reliability between base stations 105 and UEs 115. Additionally or alternatively, base stations 105 or UEs 115 may employ multiple input multiple output (MIMO) techniques that may take advantage of multi-path environments to transmit multiple spatial layers carrying the same or different coded data.

The wireless communication network 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A UE 115 may be configured with multiple downlink CCs and one or more uplink CCs for carrier aggregation. Carrier aggregation may be used with both FDD and TDD component carriers.

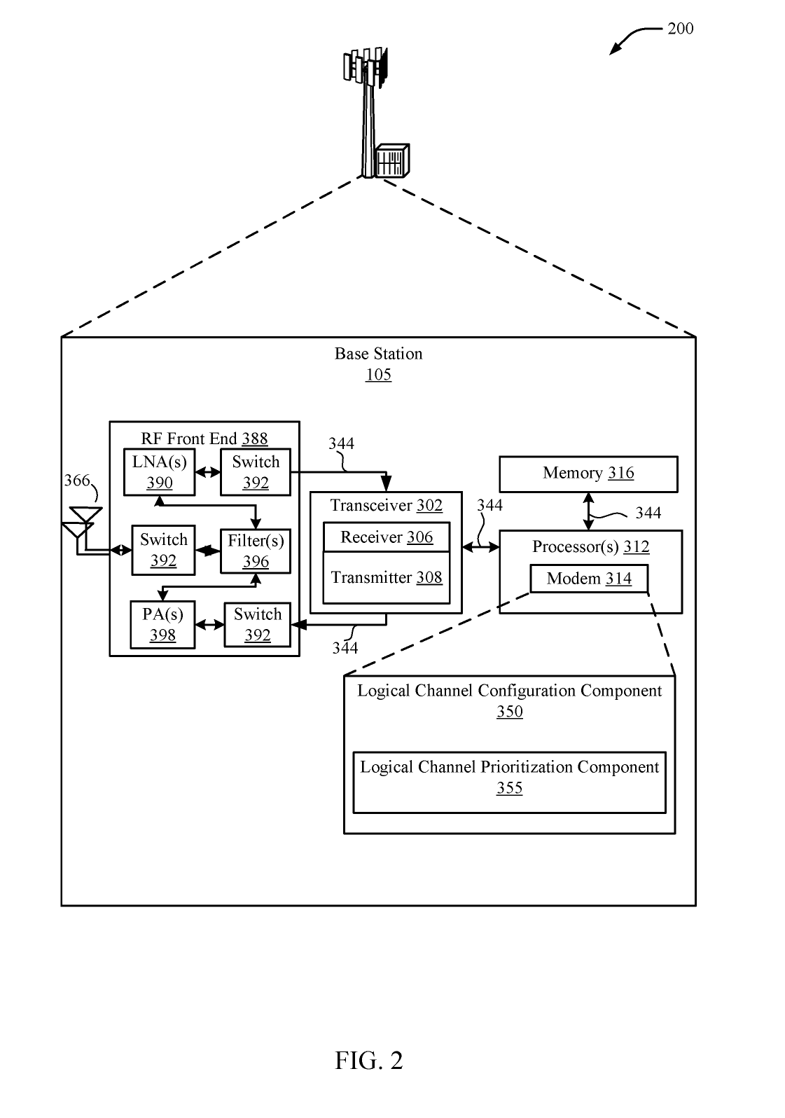

FIG. 2 describes hardware components and subcomponents of a base station 105 for implementing one or more methods (e.g., method 300) described herein in accordance with various aspects of the present disclosure. For example, one example of an implementation of the base station 105 may include a variety of components, some of which have already been described above, but including components such as one or more processors 312 and memory 316 and transceiver 302 in communication via one or more buses 344, which may operate in conjunction with the logical channel configuration component 350. As noted above, the logical channel configuration component 350 may configure a total PBR parameter value and a total BSD parameter value for a logical channel. In some examples, the logical channel configuration component 350 may configure a sub-PBR parameter value and a sub-BSD parameter value for each of a plurality of numerologies in the logical channel. The sum of the sub-PBR parameter value and the sub-BSD parameter value for each of the plurality of numerologies may be equal to the total PBR and BSD value. Additionally or alternatively, the logical channel configuration component 350 may set forth deciding how the UE may perform the LCP procedure among a plurality of numerologies (e.g., whether the uplink grants should be processed jointly or one after another).

The one or more processors 312, modem 314, memory 316, transceiver 302, RF front end 388 and one or more antennas 366, may be configured to support voice and/or data calls (simultaneously or non-simultaneously) in one or more radio access technologies. In an aspect, the one or more processors 312 can include a modem 314 that uses one or more modem processors. The various functions related to logical channel configuration component 350 may be included in modem 314 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 314 associated with logical channel configuration component 350 may be performed by transceiver 302.

Also, memory 316 may be configured to store data used herein and/or local versions of applications or logical channel configuration component 350 and/or one or more of its subcomponents being executed by at least one processor 312. Memory 316 can include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory 316 may be a non-transitory computer-readable storage medium that stores one or more computer-executable codes defining logical channel configuration component 350 and/or one or more of its subcomponents, and/or data associated therewith, when UE 115 is operating at least one processor 312 to execute logical channel configuration component 350 and/or one or more of its subcomponents.

Transceiver 302 may include at least one receiver 306 and at least one transmitter 308. Receiver 306 may include hardware, firmware, and/or software code executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one UE 115. Additionally, receiver 306 may process such received signals, and also may obtain measurements of the signals, such as, but not limited to, Ec/Io, SNR, RSRP, RSSI, etc. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, the base station 105 may include RF front end 388, which may operate in communication with one or more antennas 366 and transceiver 302 for receiving and transmitting radio transmissions, for example, wireless communications transmitted by at least one base station 105 or wireless transmissions transmitted by UE 115. RF front end 388 may be connected to one or more antennas 366 and can include one or more low-noise amplifiers (LNAs) 390, one or more switches 392, one or more power amplifiers (PAs) 398, and one or more filters 396 for transmitting and receiving RF signals.

In an aspect, LNA 390 can amplify a received signal at a desired output level. In an aspect, each LNA 390 may have a specified minimum and maximum gain values. In an aspect, RF front end 388 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 366 via RF front end 388. In an aspect, transceiver may be tuned to operate at specified frequencies such that transmitting device can communicate with, for example, one or more base stations 105 or one or more cells associated with one or more base stations 105. In an aspect, for example, modem 314 can configure transceiver 302 to operate at a specified frequency and power level based on the configuration of the transmitting device and the communication protocol used by modem 314.

In an aspect, modem 314 can be a multiband-multimode modem, which can process digital data and communicate with transceiver 302 such that the digital data is sent and received using transceiver 302. In an aspect, modem 314 can be multiband and be configured to support multiple frequency bands for a specific communications protocol. In an aspect, modem 314 can be multimode and be configured to support multiple operating networks and communications protocols. In an aspect, modem 314 can control one or more components of transmitting device (e.g., RF front end 388, transceiver 302) to enable transmission and/or reception of signals from the network based on a specified modem configuration. In an aspect, the modem configuration can be based on the mode of the modem and the frequency band in use. In another aspect, the modem configuration can be based on UE configuration information as provided by the network during cell selection and/or cell reselection.

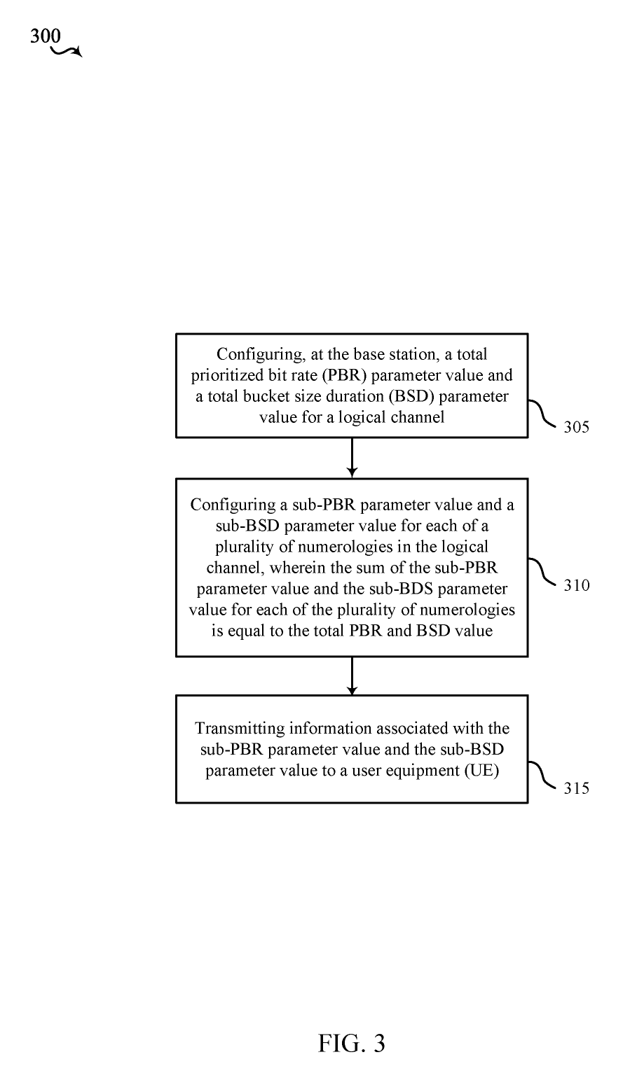

FIG. 3 is a flowchart of an example method 300 for wireless communications in accordance with aspects of the present disclosure. The method 300 may be performed by a base station 105. Although the method 300 is described below with respect to the elements of the base station 105, other components may be used to implement one or more of the steps described herein.

At block 305, the method 300 may include configuring, at the base station, a total PBR parameter value and a total BSD parameter value for a logical channel. Aspects of block 305 may be performed by the logical channel configuration component 350 described with reference to FIG. 2.

At block 310, the method 300 may include configuring a sub-PBR parameter value and a sub-BSD parameter value for each of a plurality of numerologies in the logical channel. The sum of the sub-PBR parameter value and the sub-BSD parameter value for each of the plurality of numerologies may be equal to the total PBR and BSD value. Aspects of block 310 may be performed by the logical channel configuration component 350 described with reference to FIG. 2.

At block 315, the method 300 may include transmitting information associated with the sub-PBR parameter value and the sub-BDS parameter value to the UE. Aspects of block 315 may be performed by the transceiver 302 described with reference to FIG. 2.

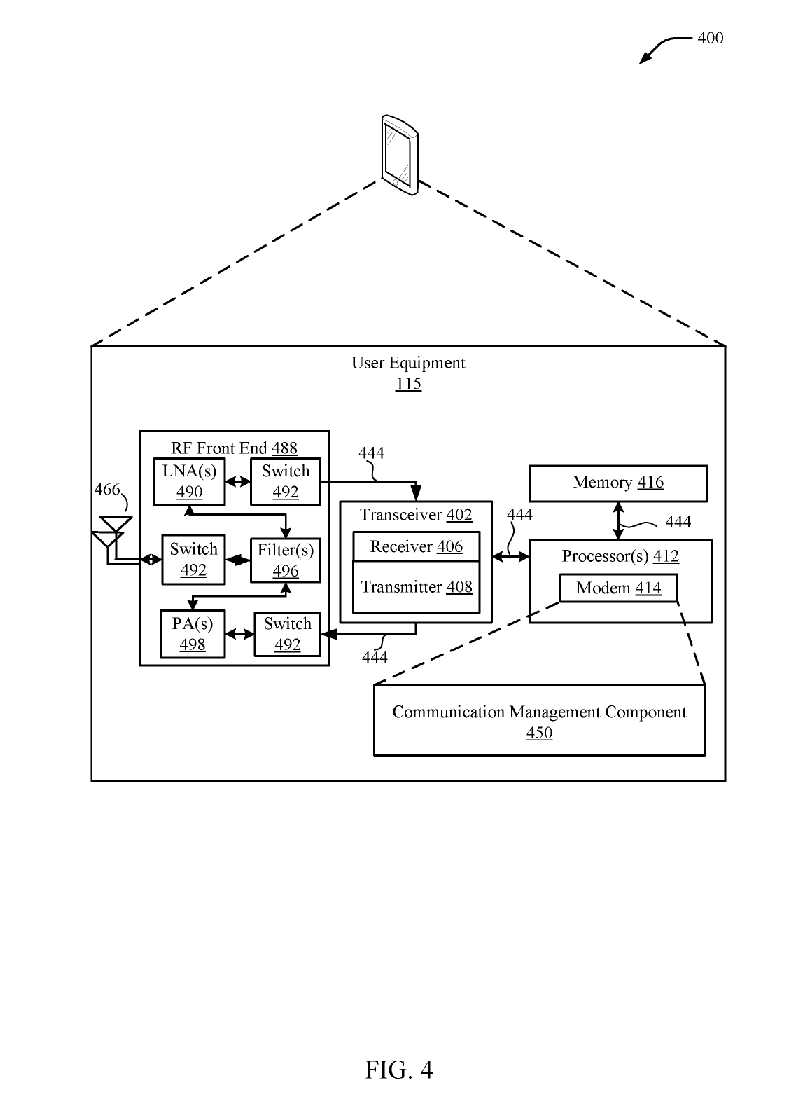

FIG. 4 describes hardware components and subcomponents of a user equipment 115 for implementing one or more methods (e.g., method 500) described herein in accordance with various aspects of the present disclosure. For example, one example of an implementation of the UE 115 may include a variety of components, some of which have already been described above, but including components such as one or more processors 412 and memory 416 and transceiver 402 in communication via one or more buses 444, which may operate in conjunction with the communication management component 450. As noted above, the communication management component 450 may configure sub-PBR and sub-BSD on different numerologies for the logical channel. In some examples, the UE 115 may decide to configure the sub-PBR and sub-BSD based on implementation of the system. Alternatively, each numerology to which the logical channel is mapped may be configured with its own set of sub-PBR and sub-BSR parameters assigned by the base station 105. In either event, the sum of the parameters for individual numerologies may be equal the total PBR and total BSD configured for the logical channel. For a logical channel mapped to multiple numerologies, network should configure a pair of PBR and BSD for each of its numerologies, with the constraint that the sum of the PBRs and BSDs allocated for the individual numerologies should equal its total PBR and BSR.

Additionally, the communication management component 450 may process the uplink grants received from the base station 105. In some examples, when processing an uplink grant, the LCP procedure may need to determine the set of logical channels to perform multiplexing. Specifically, the communication management component 450 may determine whether to perform the LCP procedure for the plurality of numerologies associated with the logical channel based on an order configured by the base station. Determining whether to include the logical channel for performing the LCP procedure may include selecting a set of logical channels to include in the LCP procedure for each numerology of the plurality of numerologies associated with the logical channel. The UE 115 may start the selection with a highest processing priority before proceeding to a lower processing priority numerology. The UE 115 may repeat the above steps for each of the next numerologies according to the processing priorities set by the base station 105, until all uplink grants are processed.

The one or more processors 412, modem 414, memory 416, transceiver 402, RF front end 488 and one or more antennas 466, may be configured to support voice and/or data calls (simultaneously or non-simultaneously) in one or more radio access technologies. In an aspect, the one or more processors 412 can include a modem 414 that uses one or more modem processors. The various functions related to communication management component 450 may be included in modem 414 and/or processors 412 and, in an aspect, can be executed by a single processor, while in other aspects, different ones of the functions may be executed by a combination of two or more different processors. For example, in an aspect, the one or more processors 412 may include any one or any combination of a modem processor, or a baseband processor, or a digital signal processor, or a transmit processor, or a receiver processor, or a transceiver processor associated with transceiver 402. In other aspects, some of the features of the one or more processors 412 and/or modem 414 associated with communication management component 450 may be performed by transceiver 402.

Also, memory 316 may be configured to store data used herein and/or local versions of applications or communication management component 450 and/or one or more of its subcomponents being executed by at least one processor 412. Memory 416 can include any type of computer-readable medium usable by a computer or at least one processor 412, such as random access memory (RAM), read only memory (ROM), tapes, magnetic discs, optical discs, volatile memory, non-volatile memory, and any combination thereof. In an aspect, for example, memory 416 may be a non-transitory computer-readable storage medium that stores one or more computer-executable codes defining communication management component 450 and/or one or more of its subcomponents, and/or data associated therewith, when UE 115 is operating at least one processor 312 to execute communication management component 450 and/or one or more of its subcomponents.

Transceiver 402 may include at least one receiver 406 and at least one transmitter 408. Receiver 406 may include hardware, firmware, and/or software code executable by a processor for receiving data, the code comprising instructions and being stored in a memory (e.g., computer-readable medium). Receiver 406 may be, for example, a radio frequency (RF) receiver. In an aspect, receiver 406 may receive signals transmitted by at least one base station 105. Additionally, receiver 406 may process such received signals, and also may obtain measurements of the signals, such as, but not limited to, Ec/Io, SNR, RSRP, RSSI, etc. Transmitter 408 may include hardware, firmware, and/or software code executable by a processor for transmitting data, the code comprising instructions and being stored in a memory (e.g., computer-readable medium). A suitable example of transmitter 408 may including, but is not limited to, an RF transmitter.

Moreover, in an aspect, the UE 115 may include RF front end 488, which may operate in communication with one or more antennas 466 and transceiver 402 for receiving and transmitting radio transmissions, for example, wireless communications transmitted by at least one base station 105 or wireless transmissions transmitted by UE 115. RF front end 488 may be connected to one or more antennas 466 and can include one or more low-noise amplifiers (LNAs) 490, one or more switches 492, one or more power amplifiers (PAs) 498, and one or more filters 496 for transmitting and receiving RF signals.

In an aspect, LNA 490 can amplify a received signal at a desired output level. In an aspect, each LNA 490 may have a specified minimum and maximum gain values. In an aspect, RF front end 488 may use one or more switches 492 to select a particular LNA 490 and its specified gain value based on a desired gain value for a particular application.

Further, for example, one or more PA(s) 498 may be used by RF front end 488 to amplify a signal for an RF output at a desired output power level. In an aspect, each PA 498 may have specified minimum and maximum gain values. In an aspect, RF front end 488 may use one or more switches 492 to select a particular PA 398 and its specified gain value based on a desired gain value for a particular application.

Also, for example, one or more filters 496 can be used by RF front end 488 to filter a received signal to obtain an input RF signal. Similarly, in an aspect, for example, a respective filter 496 can be used to filter an output from a respective PA 498 to produce an output signal for transmission. In an aspect, each filter 496 can be connected to a specific LNA 490 and/or PA 498. In an aspect, RF front end 488 can use one or more switches 492 to select a transmit or receive path using a specified filter 496, LNA 490, and/or PA 498, based on a configuration as specified by transceiver 402 and/or processor 412.

As such, transceiver 402 may be configured to transmit and receive wireless signals through one or more antennas 466 via RF front end 488. In an aspect, transceiver may be tuned to operate at specified frequencies such that transmitting device can communicate with, for example, one or more cells associated with one or more base stations 105. In an aspect, for example, modem 414 can configure transceiver 402 to operate at a specified frequency and power level based on the configuration of the transmitting device and the communication protocol used by modem 414.

In an aspect, modem 414 can be a multiband-multimode modem, which can process digital data and communicate with transceiver 402 such that the digital data is sent and received using transceiver 402. In an aspect, modem 414 can be multiband and be configured to support multiple frequency bands for a specific communications protocol. In an aspect, modem 414 can be multimode and be configured to support multiple operating networks and communications protocols. In an aspect, modem 414 can control one or more components of transmitting device (e.g., RF front end 488, transceiver 402) to enable transmission and/or reception of signals from the network based on a specified modem configuration. In an aspect, the modem configuration can be based on the mode of the modem and the frequency band in use. In another aspect, the modem configuration can be based on UE configuration information as provided by the network during cell selection and/or cell reselection.

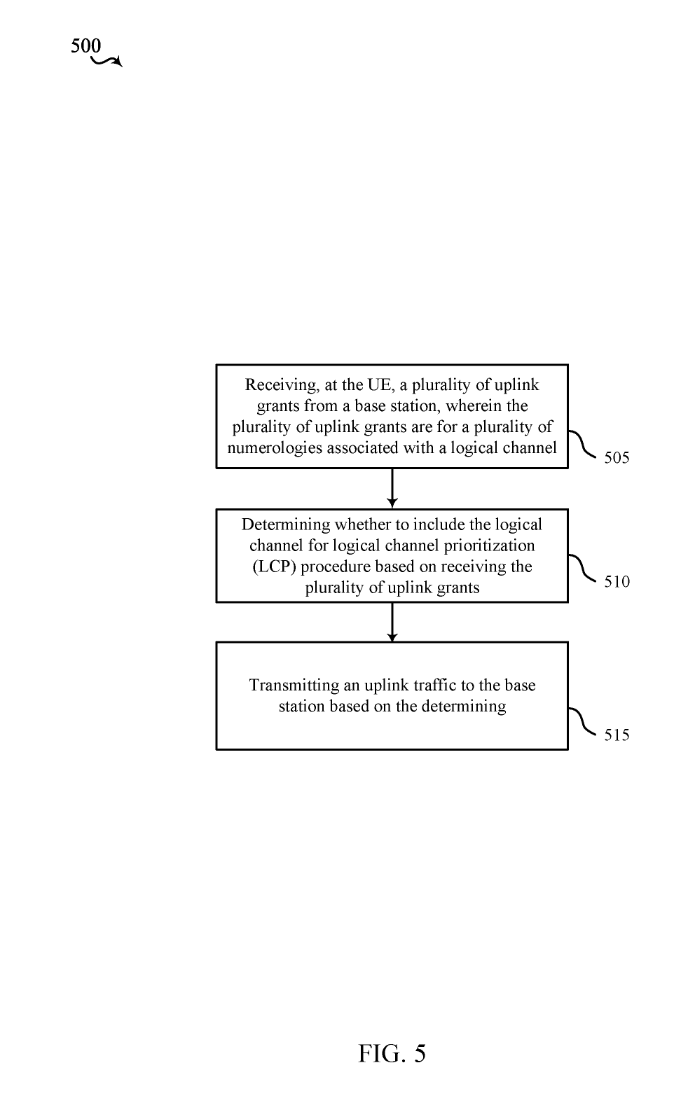

FIG. 5 is a flowchart of an example method 500 for wireless communications in accordance with aspects of the present disclosure. The method 500 may be performed by a UE 115. Although the method 500 is described below with respect to the elements of the UE 115, other components may be used to implement one or more of the steps described herein.

At block 505, the method 500 may include receiving, at the UE, a plurality of uplink grants from a base station. The plurality of uplink grants may be for a plurality of numerologies associated with a logical channel. In some examples, the UE 115 may further receive a logical channel configuration information from the base station that may include total PBR parameter value and a total BSD parameter value for the logical channel. The logical channel configuration information may further include information associated with a sub-PBR parameter value and a sub-BSD parameter value for each of the plurality of numerologies in the logical channel. The sum of the sub-PBR parameter value and the sub-BSD parameter value for each of the plurality of numerologies may be equal to the total PBR and BSD value. Aspects of block 505 may be performed by the transceiver 402 described with reference to FIG. 4.

At block 510, the method 500 may include determining whether to include the logical channel for LCP procedure based on receiving the plurality of uplink grants. In some examples, the UE may select a set of logical channels to include in the LCP procedure for each numerology of the plurality of numerologies associated with the logical channel. The UE may start the selection with a highest processing priority before proceeding to a lower processing priority numerology. The processing order/priority may be determined by either the base station or the UE itself. In some examples, determining whether to include the logical channel for the LCP procedure based on receiving the plurality of uplink grants may include determining that only one uplink grant is available for the plurality of numerologies, and applying the LCP procedure for all eligible logical channels. In some examples, the UE may determine that multiple uplink grants are available for the plurality of numerologies, and electing to include the logical channel for the LCP procedure for a numerology for the plurality of numerologies. In other examples, the UE may determine that multiple uplink grants are available for the plurality of numerologies and elect to omit the logical channel for the LCP procedure for a numerology for the plurality of numerologies. Aspects of block 510 may be performed by the communication management component 450 described with reference to FIG. 4.

At block 515, the method 500 may include transmitting an uplink traffic to the base station based on the determining. Aspects of block 515 may be performed by the transceiver 502 described with reference to FIG. 4.

In other examples, selecting the power management mode from the plurality of power management modes may include determining that the subframe fails to include the channel grant allocated to the UE. As such, the UE may select the power management mode from the plurality of power management modes supported by the UE in response to the subframe failing to include the channel grant. In such situation, the power management mode selected may configure the UE to omit decoding a shared channel region of the subframe. When the subframe fails to include a channel grant, the selection process may further include determining a channel condition between the UE and the base station and identifying a first candidate power management mode from the plurality of power management modes. Further, the UE may monitor a channel grant elapsed time period. The channel grant elapsed time period may maintain a time period since a last channel grant was received by the UE. As such, the UE maintains the periodicity of the channel grants. The UE may further determine whether the channel grant elapsed time period satisfies a threshold, and identifying a second candidate power management mode from the plurality of power management modes.

As such, the UE may select the power management from the first candidate power management mode or the second channel power management mode based on determining that the subframe includes the channel grant allocated to the UE. When the subframe includes the channel grant, the UE may select a default power management mode that configures the UE to decode both the control channel region and a shared channel region of the subframe. In contrast, when the subframe fails to include the channel grant allocated to the UE, the UE selects from the first candidate power management mode or the second candidate power management where the selected power management mode configures the UE to omit decoding a shared channel region of the subframe.

In some aspects, the channel between the UE and the base station may be subdivided into a plurality of component carries. As such, selecting the power management mode from the plurality of power management modes may comprise selecting a first power management mode for a first component carrier from the plurality of component carriers, and selecting a second power management mode for a second component carrier from the plurality of component carriers. Accordingly, each component carrier may include an independent power management mode.

Alternatively, in an example of a shared component carrier configuration, the UE may select a power management mode that is shared by the plurality of component carriers. Additionally or alternatively, the UE may select a first power management mode shared by a first set of the plurality of component carriers and a second power management mode shared by a second set of the plurality of component carriers. In some aspects, the power management mode selected may configure the UE to increase a clock rate to process the control channel region of the subframe. By increasing the clock rate for digital processing, the UE may increase the power savings by extending the UE's sleep time. Aspects of block 515 may be performed by power mode selection component 365 described with reference to FIG. 3.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

It should be noted that the techniques described above may be used for various wireless communication networks such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to 5G networks or other next generation communication systems).

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. A method for wireless communications implemented by a user equipment (UE), comprising:
receiving, at the UE, a plurality of uplink grants from a base station, wherein the plurality of uplink grants are for a plurality of numerologies associated with a logical channel;
determining whether to include the logical channel for logical channel prioritization (LCP) procedure based on receiving the plurality of uplink grants; and
transmitting an uplink traffic to the base station based on the determining.

2. The method of claim 1, further comprising:
receiving logical channel configuration information from the base station, wherein the logical channel configuration information includes a total prioritized bit rate (PBR) parameter value and a total bucket size duration (BSD) parameter value for the logical channel.

3. The method of claim 2, wherein the logical channel configuration information further includes information associated with a sub-PBR parameter value and a sub-BSD parameter value for each of the plurality of numerologies in the logical channel,
wherein the sum of the sub-PBR parameter value for each of the plurality of numerologies is equal to the total PBR parameter value, and
wherein the sum of the sub-BSD parameter value for each of the plurality of numerologies is equal to the total BSD parameter value.

4. The method of claim 1, further comprising
performing the LCP procedure for the plurality of numerologies associated with the logical channel based on an order configured by the base station.

5. The method of claim 1, wherein performing the LCP procedure, comprises:
selecting a set of logical channels to include in the LCP procedure for each numerology of the plurality of numerologies associated with the logical channel.

6. The method of claim 5, wherein the UE starts the selection with a highest processing priority before proceeding to a lower processing priority numerology.

7. The method of claim 1, wherein determining whether to include the logical channel for the LCP procedure based on receiving the plurality of uplink grants, comprises:
determining that only one uplink grant is available for the plurality of numerologies; and
applying the LCP procedure for all eligible logical channels.

8. The method of claim 1, wherein determining whether to include the logical channel for the LCP procedure based on receiving the plurality of uplink grants, comprises:
determining that multiple uplink grants are available for the plurality of numerologies; and
electing to include the logical channel for the LCP procedure for a numerology for the plurality of numerologies based on the determining.

9. The method of claim 1, wherein determining whether to include the logical channel for the LCP procedure based on receiving the plurality of uplink grants, comprises:
determining that multiple uplink grants are available for the plurality of numerologies;
electing to omit the logical channel for the LCP procedure for a numerology for the plurality of numerologies.

10. The method of claim 1, wherein determining whether to include the logical channel for the LCP procedure based on receiving the plurality of uplink grants, comprises:
determining one or both of type of data or amount of data scheduled for the logical channel; and
determining whether to include or exclude the logical channel for the LCP procedure for a numerology for the plurality of numerologies based on the one or both of the type of data or the amount of data scheduled for the logical channel.

11. An apparatus for wireless communications, comprising:
a memory configured to store instructions;
a processor communicatively coupled with the memory, the processor configured to execute the instructions to:
receive, at a user equipment (UE), a plurality of uplink grants from a base station, wherein the plurality of uplink grants are for a plurality of numerologies associated with a logical channel;
determine whether to include the logical channel for logical channel prioritization (LCP) procedure based on receiving the plurality of uplink grants; and
transmit an uplink traffic to the base station based on the determining.

12. The apparatus of claim 11, wherein the processor is further configured to execute the instructions to:
receive logical channel configuration information from the base station, wherein the logical channel configuration information includes a total prioritized bit rate (PBR) parameter value and a total bucket size duration (BSD) parameter value for the logical channel.

13. The apparatus of claim 12, wherein the logical channel configuration information further includes information associated with a sub-PBR parameter value and a sub-BSD parameter value for each of the plurality of numerologies in the logical channel,
wherein the sum of the sub-PBR parameter value for each of the plurality of numerologies is equal to the total PBR parameter value, and
wherein the sum of the sub-BSD parameter value for each of the plurality of numerologies is equal to the total BSD parameter value.

14. The apparatus of claim 11, wherein the processor is further configured to execute the instructions to:
perform the LCP procedure for the plurality of numerologies associated with the logical channel based on an order configured by the base station.

15. The apparatus of claim 14, wherein the instructions to perform the LCP procedure, are further configured to execute the instructions to:
select a set of logical channels to include in the LCP procedure for each numerology of the plurality of numerologies associated with the logical channel.

16. The apparatus of claim 15, wherein the UE starts the selection with a highest processing priority before proceeding to a lower processing priority numerology.

17. The apparatus of claim 11, wherein the instructions to determine whether to include the logical channel for the LCP procedure based on receiving the plurality of uplink grants, further include instructions to:
determine that only one uplink grant is available for the plurality of numerologies; and
apply the LCP procedure for all eligible logical channels.

18. The apparatus of claim 11, wherein the instructions to determine whether to include the logical channel for the LCP procedure based on receiving the plurality of uplink grants, further include instructions to:
determine one or both of type of data or amount of data scheduled for the logical channel; and
determine whether to include or exclude the logical channel for the LCP procedure for a numerology for the plurality of numerologies based on the one or both of the type of data or the amount of data scheduled for the logical channel.

19. A method for wireless communications implemented by a base station, comprising:
configuring, at the base station, a total prioritized bit rate (PBR) parameter value and a total bucket size duration (BSD) parameter value for a logical channel;
configuring a sub-PBR parameter value and a sub-BSD parameter value for each of a plurality of numerologies in the logical channel, wherein the sum of the sub-PBR parameter value and the sub-BSD parameter value for each of the plurality of numerologies is equal to the total PBR and BSD value; and
transmitting information associated with the sub-PBR parameter value and the sub-BSD parameter value to a user equipment (UE).

20. An apparatus for wireless communications, comprising:
a memory configured to store instructions;
a processor communicatively coupled with the memory, the processor configured to execute the instructions to:
configure, at the base station, a total PBR parameter value and a total BSD parameter value for a logical channel;
configure a sub-PBR parameter value and a sub-BSD parameter value for each of a plurality of numerologies in the logical channel, wherein the sum of the sub-PBR parameter value and the sub-BSD parameter value for each of the plurality of numerologies is equal to the total PBR and BSD value; and
transmit information associated with the sub-PBR parameter value and the sub-BDS parameter value to a user equipment (UE).
